(19) United States
(12) Patent Application Publication
(10) Pub. No.: US 2013/0046690 A1
(43) Pub. Date: Feb. 21, 2013

(54) SYSTEM AND METHOD FOR CREDENTIAL LENDING

(71) Applicants: Matthew A. Calman, Charlotte, NC (US); Erik Stephen Ross, Charlotte, NC (US)

(72) Inventors: Matthew A. Calman, Charlotte, NC (US); Erik Stephen Ross, Charlotte, NC (US)

(73) Assignee: BANK OF AMERICA CORPORATION, Charlotte, NC (US)

(21) Appl. No.: 13/210,045

(22) Filed: Aug. 15, 2011

(51) Int. Cl. G06Q 40/00

(52) U.S. Cl. 705/44

(57) ABSTRACT

Embodiments of the invention provide a method for allowing a first user to authorize a second user to perform a financial transaction using the first user's financial account information. In some embodiments, the second user conducts the transaction through the use of a mobile computing device that communicates with a point of transaction device. In some embodiments, the first user authorizes a second user to perform a financial transaction using the first user's account through the use of the personal computing device. In some embodiments, a method is provided that includes: (1) receiving a request from the first user to authorize the second user to perform a financial transaction; (2) receiving a parameters from the first user restricting a scope of the financial transaction that the second user is authorized to perform; (3) transmitting information associated with the request to a mobile computing device associated with the second user.

### BACKGROUND

Consumers conduct transactions in a variety of ways. In some transactions the consumer provides a merchant or vendor with a credit or debt card when paying for goods or services. In such transactions, typically, either the merchant or consumer swipes the consumer's card in a payment terminal to commence the transaction. Often, a consumer may loan or give their debit or credit card to another person to allow that other person to perform transactions using the consumer's account. For instance, a parent may allow a child to borrow the parents credit card to use when going out with friends (i.e., “Use my credit card to pay for your movie tickets,” “Use may credit card to pay for dinner”, etc.). In other examples, a spouse may lend the other spouse a debit card when that other spouse needs to perform a purchase (i.e., “Use my debit card when you go to the grocery store”, etc.). Such forms of lending of account information may be risky, as the account owner cannot enforce parameters regarding card use. Further, some transactions performed under this process may be foiled if the person using the card is required to show identification proving authorization to use the card.

Instead of using debit or credit cards, consumers may now use mobile phones or other mobile computing devices that are equipped with hardware and/or software that allow the mobile computing device to act as an electronic wallet, or “e-wallet”. In other words, the user's mobile computing device is configured to securely store credit card information, debit card information, bank account information, and/or other information about the ways in which the owner of the mobile computing device would like to pay for goods and services. Often, this information is securely stored in a credential file, or “credential” on the user's mobile computing device. When used in conjunction with payment terminals that are capable of communicating with mobile computing devices over secure networks, such as near field networks, users can employ this e-wallet functionality of their mobile computing devices to pay for transactions. For example, by tapping or otherwise touching an e-wallet equipped mobile computing device to a near field communication payment terminal, the consumer can pay for goods and services using credit card or debit card information that is stored in the e-wallet.

A consumer may loan or give their mobile computing device to another person to allow that other person to perform transactions using the consumer's account. However, as opposed to loaning a credit card or debit card, there are many disadvantages to loaning a mobile computing device to another person to allow that person to perform transactions. First, a lost or damaged mobile computing device is much more expensive to replace than a lost or damaged credit or debit card. Second, lending a mobile computing device to another person deprives the owner of the ability to use all of the remaining functionality of the mobile computing device, i.e., web browsing, telephone calls, text messaging, games, etc. Third, an owner of a mobile computing device may not want to lend the mobile computing device to another person for fear that the other person will use the additional functionality of the device, i.e., access the owner's email, send unauthorized text messages, etc. Lastly, the owner of a mobile computing device faces the problem of not being able to limit the transactions that a borrower can perform using the mobile computing device. For instance, if a parent lends their mobile phone to their child so that the child can pay for movie tickets, there is not an effective way to allow the parent to prevent the child from (1) making unauthorized phone calls on the parent's mobile phone; (2) making unauthorized purchases using the parent's mobile phone; or (3) accessing private information stored on the parent's mobile phone.

Accordingly, there exists a need for an improved system for allowing a first user to authorize a second user to perform a financial transaction using the account information stored on the first user's personal computing device. In particular, there exists a need for an improved system for allowing a first user to lend their credential to a second user for certain authorized transactions, where the second user commences the transaction using the second user's mobile computing device.

### BRIEF SUMMARY

Embodiments of the invention relate to apparatuses, methods, and computer program products that allow a first user to electronically authorize a second user to perform a financial transaction with a financial account of the first user.

In some embodiments of the invention, a computing device receives a request from the first user to authorize the second user to perform a financial transaction. Additionally, the computing device receives one or more parameters from the first user restricting a scope of the financial transaction that the second user is authorized to perform. Lastly, the computing device transmits information associated with the request to a mobile computing device associated with the second user.

In some embodiments of the invention, the transmitting information associated with the request comprises transmitting information associated with a credential, where the credential comprises financial information used to perform a financial transaction with the financial account. In some embodiments, the transmitting information associated with the request comprises transmitting information associated with a credential, where the credential comprises one or more of credit card information, debit card information, and bank account information.

In some embodiments of the invention, the receiving a request from the first user to authorize the second user to perform the financial transaction comprises receiving the request from a mobile phone associated with the first user. In some embodiments of the invention, the receiving a request from the first user to authorize the second user to perform the financial transaction comprises receiving the request at a network device in communication with a mobile phone associated with the first user.

In some embodiments of the invention, the transmitting information associated with the request to the mobile computing device associated with the second user comprises transmitting the information from a mobile phone associated with the first user to a mobile phone associated with the second user. In some embodiments, the transmitting information associated with the request to the mobile computing device associated with the second user comprises transmitting the information to a mobile phone associated with the second user from a network device in communication with the mobile phone.

In some embodiments of the invention, the receiving a parameter from the first user comprises receiving a monetary parameter, product parameter, merchant parameter, or time period parameter.

In some embodiments of the invention, the transmitting information associated with the request to the mobile computing device associated with the second user comprises transmitting the financial account number of the first user to the mobile computing device associated with the second user. In some embodiments of the invention, the transmitting information associated with the request to the mobile computing device associated with the second user further comprises transmitting the one or more parameters to the mobile computing device associated with the second user.

In some embodiments of the invention, a computing device further receives authentication information from the first user to use in authenticating the financial transaction performed by the second user. In some embodiments of the invention, the computing device authenticates the transaction before the second user has commenced the transaction. In some embodiments of the invention, the computer device authenticates the transaction after the second user has commenced the transaction.

In some embodiments of the invention, the authenticating the transaction comprises authenticating the transaction at a network device in communication with a point of transaction device. In some embodiments, the authenticating the transaction based on information received from a mobile phone associated with the first user.

In some embodiments of the invention, the computing device further receives a proposed financial transaction from the second user. In some embodiments the computing device further compares the proposed financial transaction to the one or more parameters received from the first user. In some embodiments of the invention the computing device further approves or denies the transaction based on the comparison.

The features, functions, and advantages that have been discussed may be achieved independently in various embodiments of the present invention or may be combined with yet other embodiments, further details of which can be seen with reference to the following description and drawings. Additionally, as will be appreciated by one of ordinary skill in the art, the features, functions, and advantages that have been discussed may include and/or be embodied as an apparatus (including, for example, a system, machine, device, computer program product, and/or the like), as a method (including, for example, a business method, computer-implemented process, and/or the like), or as any combination of the foregoing.

### BRIEF DESCRIPTION OF THE DRAWINGS

Having thus described embodiments of the invention in general terms, reference will now be made the accompanying drawings, wherein:

FIG. 1 is a flow diagram illustrating a general process flow for credential lending, in accordance with an embodiment of the invention;

FIG. 2 provides a block diagram illustrating an system and environment configured to perform credential lending, in accordance with an embodiment of the invention;

FIG. 3 provides a block diagram illustrating the first user's personal computing device of FIG. 2, in accordance with an embodiment of the invention;

FIG. 4 provides a block diagram illustrating the second user's personal computing device of FIG. 2, in accordance with an embodiment of the invention;

FIG. 5 provides a block diagram illustrating the financial institution's computer system of FIG. 2, in accordance with an embodiment of the invention;

FIG. 6 provides a block diagram illustrating the point of transaction computer system of FIG. 2, in accordance with an embodiment of the invention;

FIG. 7 is a mixed block and flow diagram of a system configured to perform credential lending, in accordance with an embodiment of the invention.

FIG. 8 is a mixed block and flow diagram of a system configured to perform credential lending, in accordance with an embodiment of the invention.

### DETAILED DESCRIPTION OF EMBODIMENTS OF THE INVENTION

### Method of Credential Lending

Embodiments of the invention relate to apparatuses, methods, and computer program products that allow a first user to lend a credential to a second user to allow the second user to perform a transaction with an account of the first user. As used herein, the term “credential” refers to any information that is stored electronically and accessible by a computing device that allows a user to use the computing device to complete various transactions.

In some embodiments, the term “credential” refers to any information that is stored electronically and accessible by a computing device that allows a user to use the computing device to complete various financial transactions, i.e., purchases, etc. In some embodiments of the invention, the credential comprises information about a bank account number, debit card number or credit card number and enables the user to perform purchases with the bank account, debit card or credit card through the use of a computing device.

In some other embodiments, the term “credential” refers to any information that is stored electronically and accessible by a computing device that grants the user certain rights or privileges via the computing device. Thus, in some embodiments of the invention, the credential may act as an electronic “key” that allows a user to use the computing device to operate an automobile, open a locked door (i.e., enter a home or apartment, etc.), or use someone's identity. As one of skill in the art will appreciate, a “credential” may authorize the user to perform any type of task.

In some embodiments, the computing device is a mobile computing device. As used herein, a “mobile computing device” is any mobile communication device, such as a cellular telecommunications device (i.e., a cell phone or mobile phone), personal digital assistant (PDA), tablet computer, lap top, a mobile Internet accessing device, or other mobile computing device capable of storing a credential and transmitting of the credential for transactions.

In some embodiments of the invention, the credential is used in connection with the electronic wallet or “e-wallet” functionality of a mobile computing device. In other words, the user's mobile computing device is configured to securely store the credential and securely use the credential with payment terminals by communicating over a secure network. In some embodiments of the invention, a user can use a credential to perform purchases or other transactions through the use of a near field communication (“NFC”) payment terminal or other type of point of transaction device. In such embodiments, the user may tap, bump or otherwise touch the e-wallet equipped mobile computing device to the NFC payment terminal in order to pay for a transaction using the account information stored in the credential.

As used herein, the term point of transaction device, or POT device comprises any type of device that may be used to commence a transaction. POT devices include, but are not limited to, NFC payment terminals, WI-FI enabled terminals, card swiping terminals, cash registers, computer systems and the like. In some embodiments, a POT device is or includes an interactive computer terminal that is configured to initiate, perform, complete, and/or facilitate one or more transactions. A POT device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo WHO, PlayStation Portable®, etc.), and/or various combinations of the foregoing.

In some embodiments, a POT device is operated in a public place (e.g., on a street corner, at the doorstep of a private residence, in an open market, at a public rest stop, etc.). In other embodiments, the POT device is additionally or alternatively operated in a place of business (e.g., in a retail store, post office, banking center, grocery store, factory floor, etc.). In accordance with some embodiments, the POT device is not owned by the user of the POT device. Rather, in some embodiments, the POT device is owned by a mobile business operator or a point-of-transaction operator (e.g., merchant, vendor, salesperson, etc.). In yet other embodiments, the POT device is owned by the financial institution offering the POT device providing functionality in accordance with embodiments of the invention described herein.

As used herein, the term “transaction” means any type of transaction in which a user participates. In some embodiments, transaction may be any type of financial transaction. In some embodiments, for example, a transaction may refer to a purchase of goods or services, a return of goods or services, a payment transaction, a credit transaction, or other interaction involving a user's bank account. In some embodiments, the transaction is one in which the user is purchasing certain goods or services from another party, such as a vendor or merchant. In other embodiments, the user may be receiving money or other funds from a third party or transferring money or other funds to a third party. In yet some other embodiments, the transaction may involve accessing an ATM. As one of skill in the art will appreciate, the term “transaction” can be any type of financial transaction in which goods, services, money, and/or other items of value are exchanged between two or more individuals or entities.

In other embodiments, the term transaction means gaining access to information about an account. For example, in some embodiments, checking the balance of an account would be a transaction.

In yet some other embodiments, the term “transaction” means any type of transaction in which a user utilizes certain rights or privileges. In some embodiments, transaction may mean the right to use an automobile. In some other embodiments, transaction may the right to access a home, apartment or other property (i.e., open a locked door, etc.). In yet some other embodiments, transaction may mean the right to access or use someone's identity, including without limitation, accessing a program, service or benefit (e.g., shopping reward program, club or museum or program membership) that is linked to someone's identity.

As discussed above, embodiments of the invention relate to apparatuses, methods, and computer program products that allow a first user to lend a credential to a second user to allow the second user to perform a transaction with an account of the first user. In some embodiments, the transaction may be a financial transaction. Thus, in some embodiments of the invention, a first user (e.g., a father) may “lend” a credential to the second user (e.g., a daughter), wherein the daughter can use father's credential in connection with the daughter's mobile computing device. Thus in some embodiments of the invention, the daughter could use her mobile computing device to perform transactions using the credit card information stored in the father's credential, such as by use with a NFC payment terminal. In other embodiments of the invention, the transaction may be one in which a user utilizes certain rights or privileges. Thus, in some embodiments of the invention, a first user (e.g., a father) may “lend” a credential to the second user (e.g., a daughter), wherein the daughter can use father's credential to operate the father's car. Alternatively, in some embodiments of the invention, a first user (e.g., home owner) may “lend” a credential to the second user (e.g., friend), wherein the friend can use the home owner's credential to open the locked doors of the home owner's home.

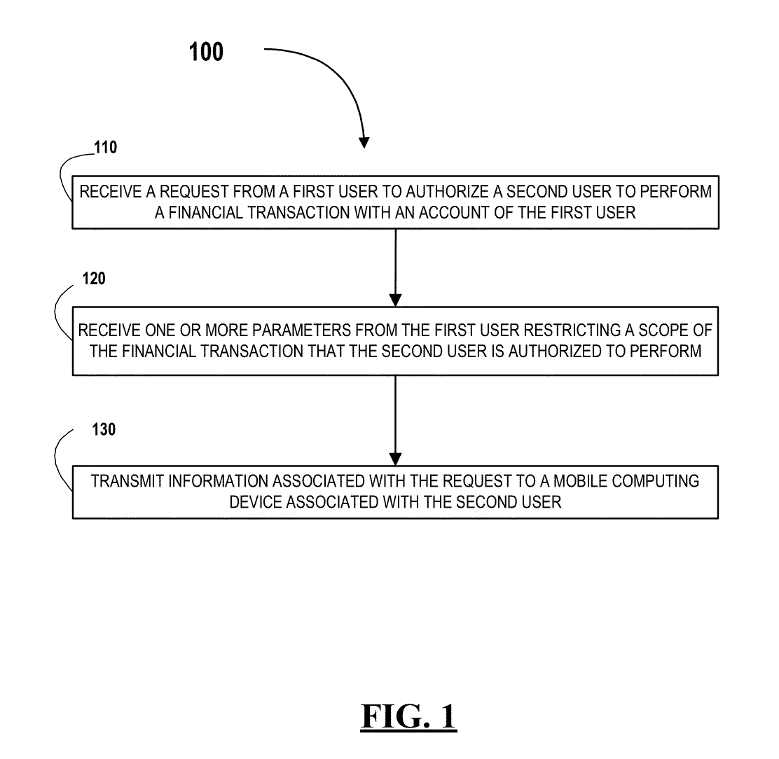

Referring now to FIG. 1, a general process flow 100 is provided for an embodiment of credential lending. In some embodiments, the process flow 100 is performed by a system (i.e., one or more apparatuses) having hardware and/or software configured to perform one or more portions of the process flow 100. In such embodiments, as represented by block 110, the system is configured to receive a request from a first user to authorize a second user to perform a financial transaction with an account of the first user. As represented by block 120, the system is also configured to receive one or more parameters from the first user restricting a scope of the financial transaction that the second user is authorized to perform. Lastly, as represented by block 130, the system is also configured to transmit information associated with the request to a mobile computing device associated with the second user.

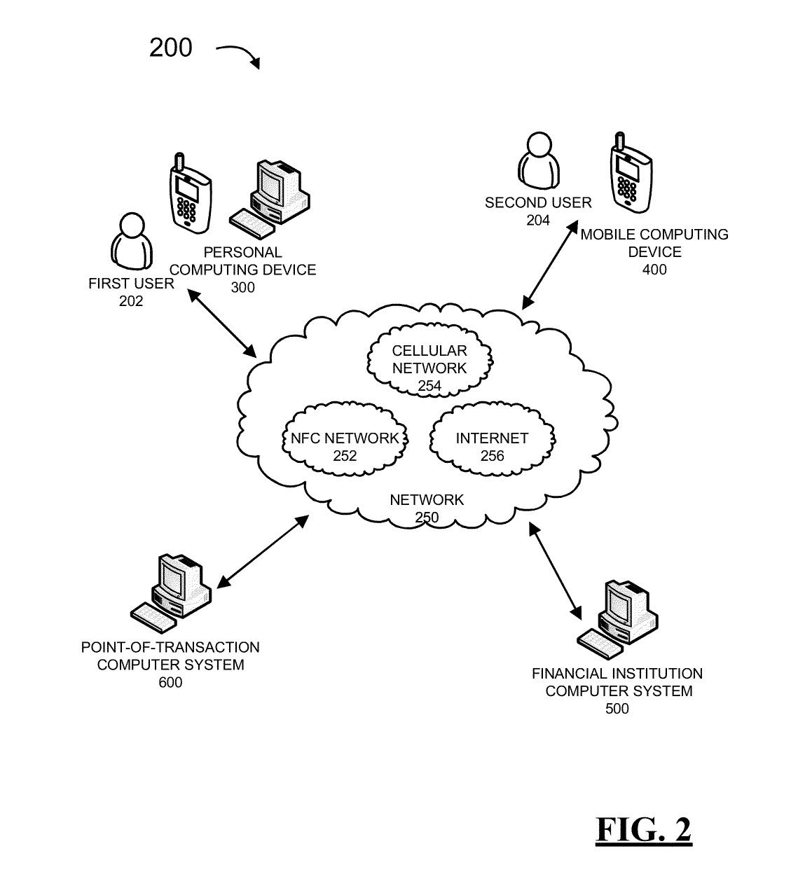

It will be understood that the system having the process flow 100 can include one or more separate and/or different apparatuses. For example, in some embodiments of the invention, a single apparatus, such as personal computing device 300 described in connection with FIG. 2, is configured to perform all of the portions of process flow 100 represented by blocks 110 to 130. In other embodiments, financial institution computer system 500 (as described in connection with FIG. 2) is configured to perform all of the portions of process flow 100. However, in some other embodiments, a first apparatus (e.g., personal computing device 300 described in connection with FIG. 2) is configured to perform the portions of process flow 100 represented by block and 110 and 120 and a second apparatus (e.g., financial institution computing device 500 described in connection with FIG. 2) is configured to perform the portions of process flow 100 represented by blocks 130.

Regarding block 110, the term “financial transaction” means any type of financial transaction. Thus, in some embodiments, the financial transaction is one in which the user is purchasing certain goods or services from another party, such as a vendor or merchant. In other embodiments, the user may be receiving money or other funds from a third party or transferring money or other funds to a third party. In yet some other embodiments, the financial transaction may involve accessing an ATM. As one of skill in the art will appreciate, the term “financial transaction” can be any type of financial transaction in which goods, services, money, and/or other items of value are exchanged between two or more individuals or entities.

Additionally, regarding block 110, the term “account” means any type of account. In some embodiments, the account is a financial account, such as a bank account, debit card account, or credit card account. As one of skill in the art will appreciate, the term “account” means any type of financial account that is linked to a source of money, funds, credit or any other type of currency that can be used in a transaction. Furthermore, the phrase “perform a financial transaction with an account” means using an account to enter into a transaction. For example, in some embodiments, a second user may perform a financial transaction with an account of the first user, by using the credential of the first user to perform a purchase.

In some other embodiments of the invention, the term “account” refers to an individual's right to perform a transaction. Thus, in some embodiments of the invention, “account” refers to an individual's right to use an automobile or open a locked door.

In some embodiments of the invention, the first user may authorize a second user to perform a financial transaction with an account of the first user by typing in the name of the second user. In some other embodiments, the first user may be able to access a list of individuals in first user's social network, such as friend and/or family, and choose the individual from the social network that the first user wants to authorize to perform financial transactions with an account of the first user.

In some embodiments of the invention, block 110 may be performed by a personal computing device associated with the first user (e.g., personal computing device 300 as described in connection with FIG. 2). As used herein, a “personal computing device” is any type of computing device, such as a personal computer, desktop computer, laptop computer, as well as any type of mobile computing device (i.e., cell phones, tablet computers, PDAs, etc.) In some embodiments, a first user may use the input functionality of a personal computing device (i.e., keyboards, mouse, touch-screen, voice recognition, etc) to input a request to authorize a second user to perform a financial transaction with an account of the first user. The first user may also input the request through any type of interface or application, such as a website (e.g., online banking website), banking application (e.g., mobile banking application accessed via a smart-phone), software program (e.g., bank software loaded onto a computer), sending a text message, etc. As one of ordinary skill in the art will appreciate, the interface or application through which a personal computing device may receive a request is not limited to any specific type of interface or application.

In some other embodiments of the invention, block 110 may be performed by a computer system (e.g., financial institution computer system 500 as described in connection with FIG. 2). In some embodiments, the computer system is in communication with a personal computing device associated with the first user via a network. In some embodiments, the first user may input a request to authorize a second user to perform a financial transaction with an account of the first user via the personal computing device and, subsequently, the personal computing device will transmit the request to the computer system, which will receive the request. In other embodiments, the computer system may receive a request to authorize a second user to perform a financial transaction with an account of the first user via any type of interface or application, such as a website (e.g., online banking website), banking application (e.g., mobile banking application accessed via a smart-phone), software program (e.g., bank software loaded onto a computer), sending a text message, etc. As one of ordinary skill in the art will appreciate, the interface or application through which a personal computing device may receive a request is not limited to any specific type of interface or application.

In the embodiments where block 110 is performed by a computer system, the computer system may receive a request to authorize a second user to perform a financial transaction with an account of the first user via any type of communication network. In some embodiments, the network may comprise a local area network (LAN), a wide area network (WAN), a global area network (GAN), near field communication network, bluetooth network or any other type of communications network or protocol. In some embodiments, the network may comprise the Internet. In some embodiments, the network may comprise first, second, third, and/or fourth-generation cellular communication networks and/or the like. For example, the network may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network may provide for wireline, wireless, or a combination of wireline and wireless communication between devices in the computer system and personal computing device.

Regarding block 120, the phrase “parameter restricting a scope of the financial transaction that the second user is authorized to perform” (or hereinafter referred to as “parameter”) refers to any type of condition on the transaction that the second user is authorized to perform using the account of the first user. In some embodiments of the invention, the parameter could be the account with which the second user is authorized to perform the transaction. For example, in some embodiments, the system may receive an indication that the first user wants the second user to use the first user's checking account. In another embodiment, the system may receive an indication that the first user wants the second user to use the first user's credit card.

Additionally, in some other embodiments, the parameter could relate to the type of transaction that the second user is authorized to perform. For example, in some embodiments, the parameter could be a monetary parameter, in which the first user places a condition on the amount of money that may be spent by the second user in making the transaction (e.g., less than a certain value, more than a certain value, or between any two values, etc.). In another embodiment, the parameter could be a product parameter, in which the first user places a condition on the types of products that may be purchased by the second user in the making the transaction (e.g., only authorized to by groceries, not authorized to buy alcohol, etc.). In yet another embodiment, the parameter could be a store parameter, in which the first user places a condition on the store, merchant or vendor with which the second user can perform the transaction (e.g., only authorized to perform a purchase at grocery store A, not authorized to perform purchases a restaurant B, etc.). In still some other embodiments, the parameter could be a time period parameter, in which the first user places a condition on the time period in which the second user is authorized to perform the transaction (e.g., authorized for the current day, authorized for one month, authorized on a specific day in the future, only authorized on weekend, etc.). As one of ordinary skill in the art will appreciate, a parameter may include any other type of condition placed on the scope of the second user's transaction.

In some embodiments of the invention, if the second user commences a transaction that is contrary to any parameter, then the transaction will be rejected. For example, if the parameter is a time period parameter that requires the transaction to only occur on Fridays, then the second user will not be able to perform a financial transaction using the first user's account on any day that is not Friday. As another example, if the parameter is a store parameter that requires the transaction to only occur at Coffee Shop A, then the second user will not be able to perform a financial transaction using the first user's account at Coffee Shop B, Coffee Shop C, Grocery Store D, etc. As another example, if the parameter is a product parameter that requires the second user to only enter into transactions involving books, then the second user will not be able to perform a financial transaction using the first user's account to purchase any other product that is not a book (e.g., food, movie tickets, clothing, etc.). Lastly, if the parameter is a monetary parameter that requires the transaction to be less than $25, then the second user will not be able to perform a financial transaction using the first user's account that is more than $25. In some embodiments, any transaction over $25 will be rejected. In other embodiments, the second user may have the opportunity to apply the $25 dollars to the transaction and pay for any difference between the $25 and the total transaction price with alternative payment means. In some embodiments of the invention, if the second user attempts to engage in non-authorized transaction using the first user's account, then the system may notify the first user by contacting the first user by email, txt message or any other method known to the art.

In some further embodiments, the first user may be able to dynamically change one or more parameters associated with use of the credential by the second user, so as to allow for financial transaction outside of the original restrictions set for the transaction. For example, the first user could receive either a message directly from the second user or from the financial institution associated with the account indicating a request to alter the parameters associated with use of the credential. In these embodiments, the first user may send altered parameters either directly to the second user's mobile device or to the financial institution via text message, email, a mobile or web banking application, etc. to thereby alter the parameters associated with the second user's use of the first user's credential for transactions.

In some embodiments of the invention, block 120 may be performed by a personal computing device associated with the first user (e.g., personal computing device 300 as described in connection with FIG. 2). In some embodiments, a first user may use the input functionality of a personal computing device (i.e., keyboards, mouse, touch-screen, voice recognition, etc) to input a parameter. The first user may also input a parameter through any type of interface or application, such as a website (e.g., online banking website), banking application (e.g., mobile banking application accessed via a smart-phone), software program (e.g., bank software loaded onto a computer), sending a text message, etc. As one of ordinary skill in the art will appreciate, the interface or application through which a personal computing device may receive a parameter is not limited to any specific type of interface or application.

In some other embodiments of the invention, block 120 may be performed by a computer system (e.g., financial institution computer system 500 as described in connection with FIG. 2). In some embodiments, the computer system is in communication with a personal computing device associated with the first user via a network. In some embodiments, the first user may input a parameter via the personal computing device and, subsequently, the personal computing device will transmit the request to the computer system, which will receive the request. In other embodiments, the first user may input a parameter through any type of interface or application, such as a website (e.g., online banking website), banking application (e.g., mobile banking application accessed via a smart-phone), software program (e.g., bank software loaded onto a computer), sending a text message, etc. As one of ordinary skill in the art will appreciate, the interface or application through which a personal computing device may receive a parameter is not limited to any specific type of interface or application.

In the embodiments where block 120 is performed by a computer system, the computer system may receive a parameter via any type of communication network. In some embodiments, the network may comprise a local area network (LAN), a wide area network (WAN), a global area network (GAN), near field communication network, bluetooth network or any other type of communications network or protocol. In some embodiments, the network may comprise the Internet. In some embodiments, the network may comprise first, second, third, and/or fourth-generation cellular communication networks and/or the like. For example, the network may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network may provide for wireline, wireless, or a combination of wireline and wireless communication between devices in the computer system and personal computing device.

Regarding block 130, the phrase “information associated with the request” means any type of information associated with the request from the first user to authorize the second user to perform a financial transaction with the account of the first user. In some embodiments of the invention, the information associated with the request may comprise the first user's credential. In other embodiments of the invention, the information associated with the request may comprise at least one of: information that identifies the account with which the second user is authorized to perform the transaction (i.e., bank account number, credit card number, etc.) or information about the parameter that the first user provided at block 120. In yet some other embodiments, information associated with the request may comprise information regarding how to contact the first user if the second user engages in an unauthorized transaction.

In some embodiments of the invention, when the second user performs the transaction with an individual or entity (i.e., vendor, merchant, store, etc.), that individual or entity may seek to authenticate the transaction. In other words, although the first user authorizes a second user to perform a financial transaction with an account of the first user, in some embodiments, the transaction may need to be authenticated before the individual or entity with whom the second user is making the transaction will finalize the transaction.

In some embodiments of the invention, the transaction may be authenticated before the second user commences the transaction. Although not described in relation to process flow 100, in some embodiments, the system configured to perform process flow 100 may authenticate the transaction by sending information about the first user's account (such as the account number, etc.) to a financial institution associated with the first user. As used herein, the term “financial institution” refers to an institution that is associated with the user. Financial institutions can include, but are not limited to, banks, building societies, credit unions, stock brokerages, asset management firms, savings and loans, money lending companies, insurance brokerages, insurance underwriters, dealers in securities, and similar businesses. In some embodiments, the financial institution may be a bank that issued the user's credit card or debit card. In other embodiments, the financial institution may be where the user has a financial institution account. In yet some other embodiments, the term financial institution may refer to a third party that stores information used to authenticate financial transactions involving the user. In these embodiments, the financial institution may verify that the account is valid (i.e., the account is open, the account has sufficient funds to allow the second user to perform the transaction, etc.) and subsequently notify the system that the transaction is authenticated. In some other embodiments, the system itself may authenticate the transaction. For instance, in embodiments where a mobile computing device performs process flow 100, the mobile computing device may authenticate the transaction by accessing information stored in the mobile computing device. Thus, in embodiments where the transaction is authenticated (e.g., by a financial institution computer system, by a mobile computing device, etc.), the information associated with the request (block 130) may comprise information indicated that the transaction is authenticated.

In some embodiments where the transaction is authenticated before the second user commences the transaction, the first user's account may be altered to reflect the authorized transaction. For example, where first user inputted a monetary parameter to limit the maximum amount that the second user may spend during the transaction, the first user's account could be automatically charged that amount. In some other embodiments, including embodiments where the first user did not input a monetary parameter, a hold could be placed on the first user's account to reflect the fact that the second user will be using the first user's account to perform a financial transaction. In some embodiments, if the first user provides a monetary parameter that exceeds the amount of available funds or credit in the applicable account associated with the first user, then the financial system (or system configured to perform process flow 100) may deny the first user's authorization of the second user to perform the transaction.

Returning back to the authentication of transactions, in some other embodiments of the invention, where the transaction is not authenticated before the second user commences the transaction, the information associated with the request (block 130) may include data, software, applications or other information that may be used by a point of transaction device (such as point of transaction computer system 600 as described in relation to FIG. 2) to authenticate the second user's transaction, including but not limited to card security codes (CSC), card verification data (CVD), card verification value (CVV or CVV2), card verification value code (CVVC), card verification code (CVC or CVC2), verification code (V-Code or V Code), or card code verification (CCV) (collectively, “fraud protection codes”) or software/applications that generate fraud protection codes. In these embodiments, the point of transaction device may communicate with a computer system (such as financial institution computer system 600 as described in relation to FIG. 2) to authenticate the transaction.

Returning back to block 130, in some embodiments of the invention, block 130 may be performed by a personal computing device associated with the first user (e.g., personal computing device 300 as described in connection with FIG. 2). In these embodiments, the personal computing device associated with the first user transmits the information associated with the request to a mobile computing device associated with the second user.

In some other embodiments of the invention, block 130 may be performed by a computer system (e.g., financial institution computer system 500 as described in connection with FIG. 2). In some embodiments, the computer system is in communication with a mobile computing device associated with the second user via a network and may transmit the information associated with the request to the mobile computing device. In some embodiments, the network may comprise a local area network (LAN), a wide area network (WAN), a global area network (GAN), near field communication network, bluetooth network or any other type of communications network or protocol. In some embodiments, the network may comprise the Internet. In some embodiments, the network may comprise first, second, third, and/or fourth-generation cellular communication networks and/or the like. For example, the network may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network may provide for wireline, wireless, or a combination of wireline and wireless communication between devices in the computer system and personal computing device.

Although the embodiments of the invention disclosed in relation to FIG. 1 relates to credential lending in the context of financial transactions, as one of skill in the art will appreciate, the systems, methods, and apparatuses of the present invention may involve credential lending relating to other types of transactions (i.e., the first user lending a credential to the second user to allow the second user to conduct different types of transactions.).

For example, in some embodiments of the invention, a first user may lend a credential to a second user that would enable the second user to operate the first user's automobile. Thus, in such an embodiment, the first user may input certain parameters that limit the second user's use of the first user's automobile. For example, the first user could input parameters that limit the times during which the second user can use the first user's automobile (e.g., only on Mondays, from 8 a.m. to 5 p.m., etc.). Additionally, the first user could input parameters that limit the geographic locations in which the second user is authorized to use the first user's automobile (e.g., only in the first user's town, only within the first user's state, etc.).

As another example, in some embodiments, the systems, methods, and apparatuses of the present invention may allow a first user to authorize a second user to enter the first user's home. Thus according to such embodiments, the second user could use a mobile phone containing the first user's credential to open a locked door at the first user's home. In such embodiments, the first user may input certain parameters that limit the second user's ability to open the locked door (e.g., times during which the second user is authorized to open the door, etc.)

As yet an additional example, in some embodiments, the systems, methods, and apparatuses of the present invention may allow a first user to authorize a second user to use the first user's membership (e.g., gym membership, museum membership, rewards program membership, etc.). Thus according to such embodiments, the second user could use a mobile phone containing the first user's credential to access the benefits of the membership. In such embodiments, the first user may input certain parameters that limit the second user's ability to use the membership (e.g., times during which the second user is authorized to use the membership etc.).

### Credential Lending System and Environment

FIG. 2 provides a block diagram illustrating a system and environment 200 for lending a credential from a first user to a second user, in accordance with an embodiment of the invention. As illustrated in FIG. 2, the credential lending environment 200 includes a first user 202 and a personal computing device 300 associated with first user 202. The environment 200 also includes a second user 204 and a mobile computing device 400 associated with second user 202. Environment 200 also includes a financial institution computer system 500 and a point of transaction computer system 600.

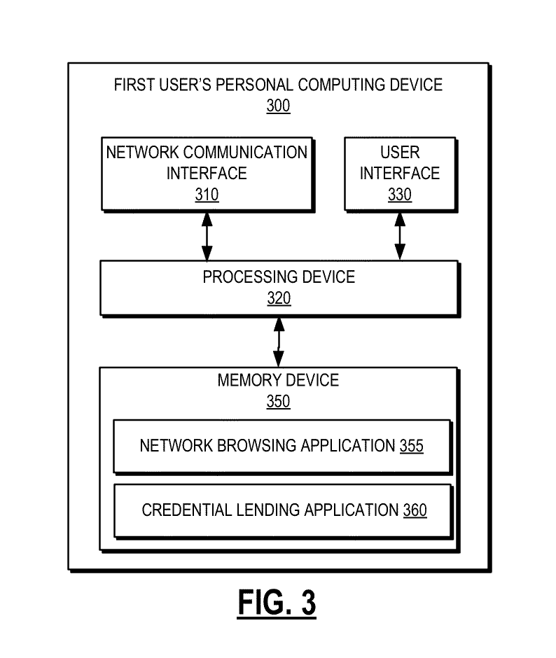

Personal computing device 300, mobile computing device 400, financial institution computer system 500, and a point of transaction computer system 600 are each configured to communicate with each other over a network 250. Personal computing device 300, mobile computing device 400, financial institution computer system 500, and a point of transaction computer system 600 are each described in greater detail below with reference to FIGS. 3-6. The network 250 may include a local area network (LAN), a wide area network (WAN), a global area network (GAN), near field communication network, bluetooth network or any other type of communications network or protocol. In some embodiments, network 250 may comprise the Internet. In addition, network 250 may include first, second, third, and/or fourth-generation cellular communication networks and/or the like. For example, the network 250 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network 250 may provide for wireline, wireless, or a combination of wireline and wireless communication between devices in the network.

In the embodiment of the invention depicted in FIG. 2, network 250 comprises near field communication (“NFC”) network 252, cellular network 254, and Internet 256. In some embodiments, personal computing device 300 may communicate with mobile computing device 400 via NFC network 252 or Internet 256. For example, in some embodiments, personal computing device 300 may communicate with mobile computing device 400 when personal computing device 300 transmits information associated with the request to mobile computing device 400 (see block 130).

In some embodiments, personal computing device 300 may communicate with financial institution computer system 500 via cellular network 254 or Internet 256. For example, in some embodiments, personal computing device 300 may communicate with financial institution computer system 500 when financial institution computer system 500 receives a request from a first user (see block 110) or when financial institution computer system 500 receives parameters from the first user (see block 120) or when personal computing device 300 seeks to authenticate the transaction prior to the second user commencing the transaction.

In some embodiments, mobile computing device 400 may communicate with financial institution computer system 500 via cellular network 254 or Internet 256. For example, in some embodiments, mobile computing device 400 may communicate with financial institution computer system 500 when financial institution computer system 500 transmits information associated with the request to mobile computing device 400 (see block 130).

Lastly, in some embodiments, point of transaction computer system 600 may communicate with financial institution computer system 600 via Internet 256. For example, in some embodiments, point of transaction computer system 600 may communicate with financial institution computer system when point of transaction computer system 600 seeks to authenticate a transaction made by a second user.

Referring now to FIG. 3, the personal computing device 300 associated with first user 202 includes various features, such as a network communication interface 310, a processing device 320, a user interface 330, and a memory device 350. The network communication interface 310 includes a device that allows the personal computing device 300 to communicate over the network 250 (shown in FIG. 2). In addition, a network browsing application 355 is stored in the memory device 350. The network browsing application 355 provides for the first user to establish network communication with the mobile computing system 400 and/or financial institution computing system 500 (shown in FIG. 2) for the purpose of initiating the lending of a credential, in accordance with embodiments of the present invention. Furthermore, a credential lending application 360 is stored in the memory device 350. The credential lending application 360 provides for the first user to use personal computing system 300 to perform the functionality of lending of a credential, in accordance with embodiments of the present invention.

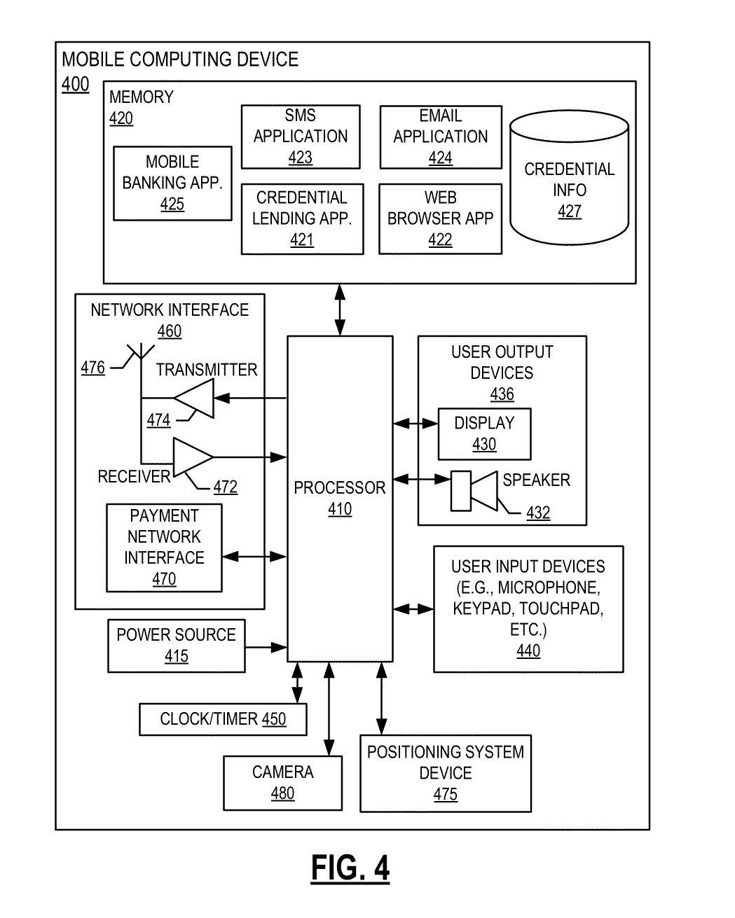

Referring now to FIG. 4, the mobile computing device 400 associated with the user 402 is described. FIG. 4 provides a block diagram illustrating mobile computing device 500 in accordance with embodiments of the invention. In one embodiment of the invention, the mobile computing device 400 is a mobile telephone. However, it should be understood, however, that a mobile telephone is merely illustrative of one type of mobile computing device 400 that may benefit from, employ, or otherwise be involved with embodiments of the present invention and, therefore, should not be taken to limit the scope of embodiments of the present invention. Other types of mobile computing devices 400 may include portable digital assistants (PDAs), pagers, mobile televisions, gaming devices, laptop computers, cameras, video recorders, audio/video player, radio, GPS devices, or any combination of the aforementioned.

The mobile computing device 400 generally includes a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the mobile computing device 400. For example, the processor 410 may include a digital signal processor device, a microprocessor device, and various analog to digital converters, digital to analog converters, and/or other support circuits. Control and signal processing functions of the mobile computing device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile computing device 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 800. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. In some embodiments where network 350 is a wireless telephone network, the signals may include signaling information in accordance with the air interface standard of the applicable cellular system of the wireless telephone network. In this regard, the mobile computing device 400 may be configured to operate with one or more air interface standards, communication protocols, modulation types, and access types. By way of illustration, the mobile computing device 400 may be configured to operate in accordance with any of a number of first, second, third, and/or fourth-generation communication protocols and/or the like. For example, the mobile computing device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile computing device 400 may also be configured to operate in accordance with non-cellular communication mechanisms, such as via a wireless local area network (WLAN), near field communication network, or other communication/data networks.

The network interface 460 may also include a payment network interface 470. The payment network interface 470 may include software, such as encryption software, and hardware, such as a modem, for communicating information to and/or from one or more devices on a network 250. For example, the mobile computing device 400 may be configured so that it can be used as a credit or debit card by, for example, wirelessly communicating credentials or other account information to point of transaction computer system 600.

As described above, the mobile computing device 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile computing device 400 to receive data from user 402, may include any of a number of devices allowing the mobile computing device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile computing device 400 may also include a positioning system device 475 that is configured to be used by a positioning system to determine a location of the mobile computing device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile computing device 400. In other embodiments, the positioning system device 475 includes a proximity sensor or transmitter, such as an RFID tag, that can sense or be sensed by devices known to be located proximate a merchant or other location to determine that the consumer mobile computing device 400 is located proximate these known devices.

The mobile computing device 400 further includes a power source 415, such as a battery, for powering various circuits and other devices that are used to operate the mobile computing device 400. Embodiments of the mobile computing device 400 may also include a clock or other timer 450 configured to determine and, in some cases, communicate actual or relative time to the processor 410 or one or more other devices.

The mobile computing device 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile computing device 400 described herein. For example, the memory 420 may include such applications as a credential lending application 421, conventional web browser application 422, a SMS application 423, and email application 424 and/or mobile banking application 425. These applications also typically provide a graphical user interface (GUI) on the display 430 that allows user 402 to communicate with point of transaction computer system 700 and/or financial institution computer system 600. In some embodiments, memory 420 may store credential information 427. Credential information 427 may comprise and data or information relating to the credential of the first user, such as information about the first user's account with which the second user is authorized to perform a transaction, parameters concerning the transaction, and/or information, data or applications used to authenticate the transaction.

The memory 420 can also store any of a number of pieces of information, and data, used by the mobile computing device 400 and the applications and devices that make up the mobile computing device 400 or are in communication with the mobile computing device 400 to implement the functions of the mobile computing device 400 and/or the other systems described herein.

As used herein, a “processor” (such as the processor 410) or a “processing device,” generally refers to a device or combination of devices having circuitry used for implementing the communication and/or logic functions of a particular system. For example, a processor 410 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor 410 may further include functionality to operate one or more software programs based on computer-executable program code thereof, which may be stored in a memory. As the phrase is used herein, a processor 410 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory” (such as memory 420) or “memory device,” generally refers to a device or combination of devices that store one or more forms of computer-readable media for storing data and/or computer-executable program code/instructions. Computer-readable media is defined in greater detail below. For example, in one embodiment, the memory 420 includes any computer memory that provides an actual or virtual space to temporarily or permanently store data and/or commands provided to the processor 410 when it carries out its functions described herein.

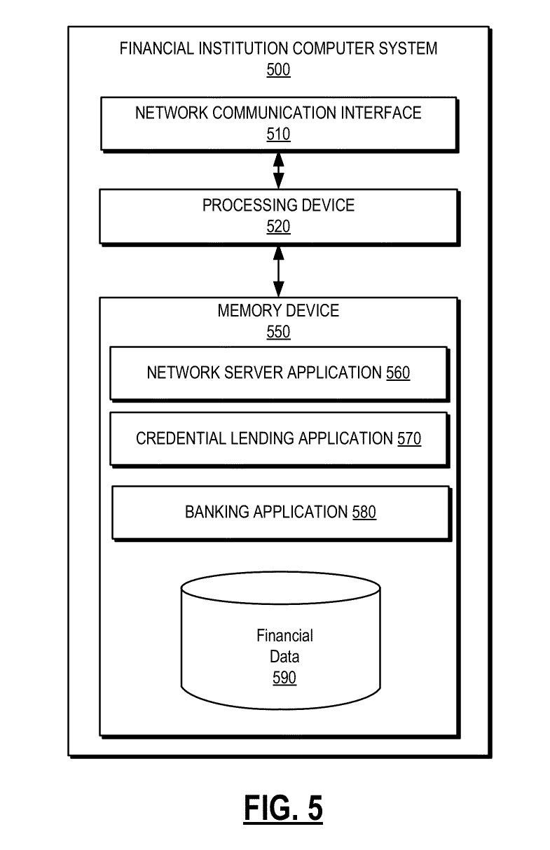

FIG. 5 provides a block diagram illustrating the financial institution computer system 500 in greater detail, in accordance with an embodiment of the invention. As illustrated in FIG. 5, in one embodiment of the invention, the financial institution computer system 500 includes a processing device 520 operatively coupled to a network communication interface 510 and a memory device 550. In certain embodiments, the financial institution computer system 500 is operated by a first entity, such as a financial institution.

It should be understood that the memory device 550 may include one or more databases or other data structures/repositories. The memory device 550 also includes computer-executable program code that instructs the processing device 520 to operate the network communication interface 510 to perform certain communication functions of the financial institution computer system 500 described herein. For example, in one embodiment of the financial institution computer system 500, the memory device 550 includes, but is not limited to, a network server application 560, an authentication application 570, banking application 680, and other computer-executable instructions or other data. In some embodiments of the invention, authentication application 570 performs the task of authenticating a transaction that a first user has authorized a second user to perform. The computer-executable program code of the network server application 560, the authentication application 570, or the banking application 580 may instruct the processing device 520 to perform certain logic, data-processing, and data-storing functions of the financial institution computer system 500 described herein, as well as communication functions of the financial institution computer system 500.

In one embodiment, memory device 550 includes financial data 590. Financial data 590 may comprise and data or information relating to the first user's accounts and/or credentials, such as credit card information, debit card information, bank account information, and/or information necessary to authenticate a transaction for which the second user has been authorized using the first user's credential. The network server application 560, the authentication application 570, and/or the banking application 580 are configured to access financial data 590 when configured to perform the steps of the present invention.

While the embodiment of the invention depicted in FIG. 5 indicates that financial data 590 is stored in memory device 550 of financial institution computer system 500, in other embodiments of the invention, financial data 590 may be stored in memory devices in other computer systems, including computer systems operated by third parties. In such embodiments, financial institution computer system may still access the financial data 590 through the use of network communication interface 510.

As used herein, a “communication interface” generally includes a modem, server, transceiver, and/or other device for communicating with other devices on a network, and/or a user interface for communicating with one or more customers. Referring again to FIG. 5, the network communication interface 510 is a communication interface having one or more communication devices configured to communicate with one or more other devices on the network 250, such as the personal computing device 300 and point of transaction computer system 600. The processing device 520 is configured to use the network communication interface 510 to transmit and/or receive data and/or commands to and/or from the other devices connected to the network 250.

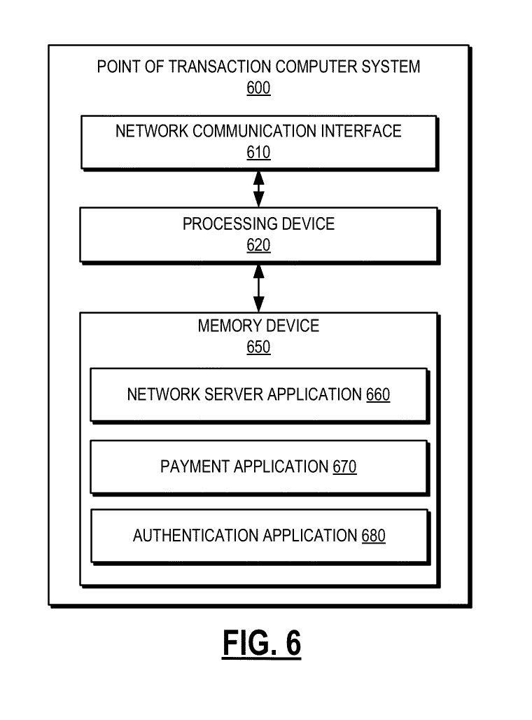

FIG. 6 provides a block diagram illustrating the point of transaction computer system 600 in greater detail, in accordance with an embodiment of the invention. In some embodiments, point of transaction computer system is a POT device. As illustrated in FIG. 6, in one embodiment of the invention, the point of transaction computer system 600 includes a processing device 620 operatively coupled to a network communication interface 610 and a memory device 650. In certain embodiments, the financial institution computer system 600 is operated by a merchant or other commercial entity that may enter into transactions with the second user.

It should be understood that the memory device 650 may include one or more databases or other data structures/repositories. The memory device 650 also includes computer-executable program code that instructs the processing device 620 to operate the network communication interface 610 to perform certain communication functions of the point of transaction computer system 600 described herein. For example, in one embodiment of the point of transaction computer system 600, the memory device 650 includes, but is not limited to, a network server application 660, payment application 670 and an authentication application 680. The computer-executable program code of the network server application 660, the payment application 670, or the authentication application 680 may instruct the processing device 620 to perform certain logic, data-processing, authentication, and data-storing functions of the point of transaction computer system 600 described herein, as well as communication functions of the point of transaction computer system 600. In some embodiments, point of transaction computer system 600 may execute payment application 670 to initiate functionality configured to conduct a transaction, such as initiating the functionality that allows a near field communication payment terminal to conduct transactions with a second user's mobile phone. Additionally, in some embodiments, point of transaction computer system 600 may execute authentication application 680 to perform the functionality configured to authenticate a transaction.

### Specific Embodiments of Credential Lending

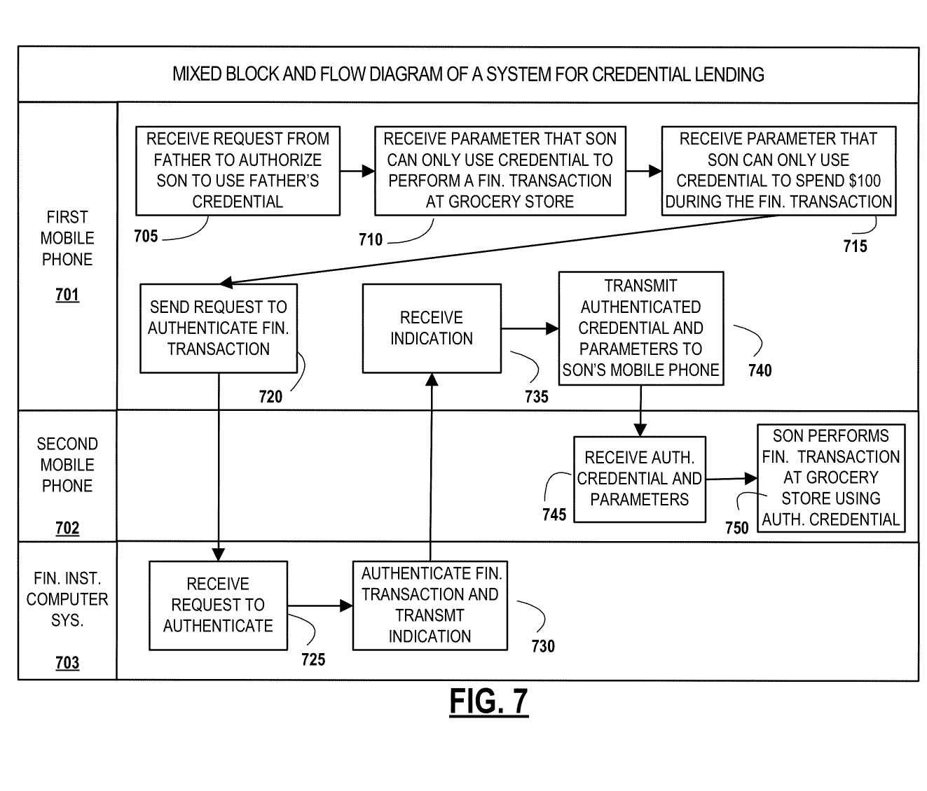

Referring now to FIG. 7, a mixed block and flow diagram of a system 700 for credential lending. In general terms, FIG. 7 illustrates an embodiments of the invention in which a father user a first mobile phone 701 (which is associated with the father) to authorize a son to perform a financial transaction with the father's credential through the use of a mobile phone associated with the son. In other words, the father will be lending his credential to the son. In the embodiment of the invention depicted in FIG. 7, first mobile phone 701 is one embodiment of personal computing device 300, second mobile phone 702 is one embodiment of mobile computing device 400, and financial institution computer system 703 is one embodiment of financial institution computer system 500. Additionally, it will be understood that the mixed block and flow diagram of a system 700 in FIG. 7 represents an embodiment of process flow 100.

At block 705, first mobile phone 701 receives a request from the father to authorize the son to use the father's credential. In the embodiment of the invention depicted at block 705, the father's credential is stored on first mobile phone 701 and the credential contains information about the father's checking account. The father is able to use the e-wallet functionality of first mobile phone 701 with certain payment terminals (e.g., NFC payment terminals, etc.) to perform financial transactions that are charged to the father's checking account.

At block 705, the father inputs the request through any known application of first mobile phone 701. In some embodiments, the father may input the request through a mobile banking application. In some other embodiments, the father may input the request through a mobile credential lending application and/or social network application. In yet some other embodiments, the father may input the request by sending a txt message to a recipient address affiliated with the financial institution that contains the father's checking account or accessing the financial institution's website through the mobile web browser of first mobile phone 701.

Additionally, at block 705, the father may input the request through any known functionality of first mobile phone 701. In some embodiments, the father may input the request through the use of the keypad or touch pad of first mobile phone 701. In other embodiments, the father may input the request through the use of voice recognition technology or any other input means known to one skilled in the art.

At block 710, first mobile phone 701 receives a parameter that the son can only use the father's credential for performing a financial transaction at the grocery store. In this embodiment, first mobile phone 701 receives this parameter from the father through the input functionality of the first mobile phone 701, i.e., keypad, touch screen, voice recognition, etc. In some embodiments of block 710, first mobile phone 701 may prompt the father to input any parameters after first mobile phone 701 receives the request at block 705. In other embodiments, first mobile phone 701 may not prompt the father to input parameters and the father can input them independently through the functionality of first mobile phone 701.

At block 715, first mobile phone 701 receives a parameter that the son can only use the father's credential to spend at most $100 during the financial transaction at the grocery store. In this embodiment, first mobile phone 701 receives this parameter from the father through the input functionality of the first mobile phone 701, i.e., keypad, touch screen, voice recognition, etc. In some embodiments of block 710, first mobile phone 701 may prompt the father to input any additional parameters after first mobile phone 701 receives the first parameter at block 710. In other embodiments, first mobile phone 701 may not prompt the father to input additional parameters and the father can input them independently through the functionality of first mobile phone 701.

At block 720, after the father has inputted all parameters for the transaction that the son is authorized to perform using the father's credential, first mobile phone 701 sends a request to authenticate the transaction to financial institution computer system 703. In this embodiment, by authenticating the transaction before the son commences the financial transaction at the grocery store, the son will not need to later authenticate the financial transaction while at a point of transaction device located at the grocery store.

In some embodiments of the invention, first mobile phone 701 sends the request to authenticate the financial transaction to financial institution computer system 703 via a cellular network. In some other embodiments, first mobile phone 701 sends the request to authenticate the financial transaction to financial institution computer system 703 via the Internet. In still some other embodiments of the invention, first mobile phone 701 sends the request to authenticate the financial transaction to financial institution computer system 703 via any known communication protocol or combinations thereof. First mobile phone 701 may send the request to authenticate the financial transaction to financial institution computer system 703 via a wireless network, wireline network or combination thereof. At block 725, financial institution computer system 703 receives the request to authenticate the financial transaction from first mobile phone 701.

At block 730, financial institution computer system 703 authenticates the financial transaction that the father authorized the son to perform using the father's credential, which contains information about his checking account (see block 705). In this embodiments, where the father authorized the son to spend $100 (see block 715) financial institution computer system determines whether the father's checking account contains at least $100. In some embodiments, financial institution computer system 703 may place a hold on the father's checking account for $100 and in other embodiments, financial institution computer system 703 may immediately deduct the $100 from the father's checking account.

Additionally, at block 730, once the financial transaction has been authenticated, financial institution computer system 703 transmits and indication to first mobile phone 701 that indicates that financial computer system 703 has authenticated the financial transaction. In some other embodiments, financial instruction computer system 703 transmits the indication to first mobile phone 701 via the Internet. In still some other embodiments of the invention, financial instruction computer system 703 sends the indication to first mobile phone 701 via any known communication protocol or combinations thereof. Financial institution computer system 703 may send the indication to first mobile phone 701 via a wireless network, wireline network or combination thereof. At block 735, first mobile phone 701 receives the indication from financial institution computer system 703.

At block 740, first mobile phone 701 transmits the authenticated credential to second mobile phone 702, along with information about the parameters that the father provided at blocks 710 and 715. The credential is “authenticated” because financial institution computer system 703 authenticated the authorized financial transaction at block 730. Thus, when the son uses the father's credential to perform a financial transaction at the grocery store, the point of transaction device at the grocery store will not need to further authenticate the transaction (i.e., authenticate the validity of the father's checking account information, which is stored in the father's credential).

In this embodiment of the invention, the father's credential, which is transmitted from first mobile phone 701 to second mobile phone 702, comprises information that identifies the father's checking account, such as a checking account number and bank routing number. In this embodiments, since the credential is also authenticated, the credential comprises information that indicates that the transaction that the son is authorized to perform has already been authenticated by financial computer system 703. In other embodiments, the information that indicates that the transaction is authorized may be separate from the credential.

In this embodiment of block 740, first mobile phone 701 also transmits to second mobile phone 702 information about the parameters that the father provided at blocks 710 and 715. This information is either part of the father's credential or it may be stored as separate data on second mobile phone 702. In some embodiments of the invention, when the son uses the father's credential to perform a financial transaction with a merchant, the merchant's point of transaction device uses the information about the parameters to confirm that the son is using the father's credential pursuant to the father's parameters. For example, if the son tries to use the father's credential at a book store, the point of transaction device at the book store will deny the financial transaction because the information about the father's parameters indicates that the financial transaction must take place at a grocery store.

At block 740, first mobile phone 701 transmits the father's credential and information about the parameters to second mobile phone 702 via a NFC network. However, in some other embodiments, first mobile phone 701 transmits the father's credential and information about the parameters to second mobile phone 702 via the Internet. In still some other embodiments of the invention, first mobile phone 701 transmits the father's credential and information about the parameters to second mobile phone 702 via any known communication protocol or combinations thereof. First mobile phone 701 may transmit the father's credential and information about the parameters to second mobile phone 702 via a wireless network, wireline network or combination thereof. At block 745, second mobile phone 702 receives the father's credential and information about the parameters from mobile phone 701. In some embodiments of the invention, second mobile phone 702, stores the father's credential and information about the parameters in a memory device in second mobile phone 702.

At block 750, the son uses second mobile phone 702 to perform a financial transaction at the grocery store. In some embodiments of the invention, second mobile phone 702 is equipped with e-wallet functionality, so that second mobile phone 702 may use the father's credential to perform a financial transaction using a NFC payment terminal or other similarly equipped payment terminal. In such embodiments, the son bumps, taps or otherwise physically touches second mobile phone 702 to the NFC payment terminal to commence the transaction. As one of skill in the art will appreciate, the son may use any other means known in the art to use second mobile phone 702 to perform a financial transaction using the father's credential.

At block 750, since the transaction was already authorized at block 730, the point of transaction device at the grocery store (e.g., the NFC payment terminal) does not need to authenticate the validity of the credential or the father's checking account. However, at block 750, the point of transaction device at the grocery store does verify that the son's financial transaction does comply with the parameters that the father provided at blocks 710 and 715. In some embodiments, the point of transaction device at the grocery store contains information that indicates that the point of transaction device is being used at a grocery store, thus the point of transaction device is able to verify that the son is complying with the father's store parameter (see block 710). Additionally, in some embodiments, the point of transaction device at the grocery store will compare the final value of the son's financial transaction to the monetary parameter (e.g., $100 limit) that the father provided at block 715. If the son's financial transaction is less than or equal to $100 dollars, than the point of transaction device at the grocery store will allow the son to complete the financial transaction using the father's credential. However, if the son's transaction exceeds $100, then in some embodiments the point of transaction device at the grocery store will deny the financial transaction. In some other embodiments of the invention, if the son's transaction exceeds $100, then point of transaction device will allow the son to pay the difference between the sum of the financial transaction and the $100 from the father's parameter. Additionally, at block 750, once the son finalizes the financial transaction using the using second mobile phone 702 and the father's credential, then the son leaves the grocery store with the groceries that he purchased.

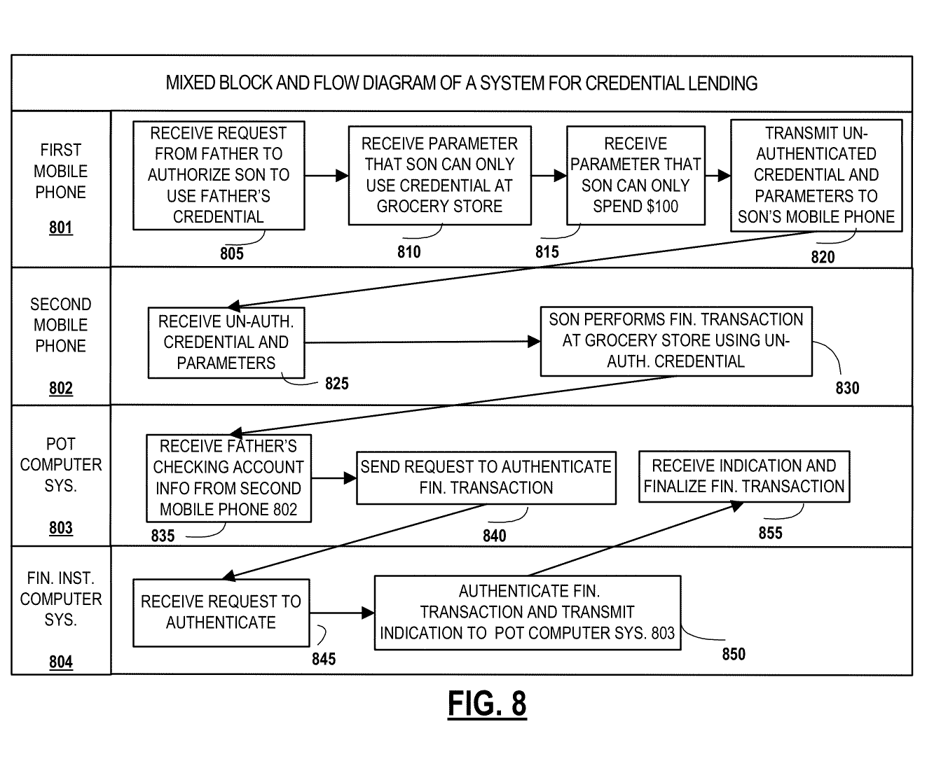

Referring now to FIG. 8, a mixed block and flow diagram of a system 800 for credential lending. In general terms, FIG. 8 illustrates an embodiments of the invention in which a father user a first mobile phone 801 (which is associated with the father) to authorize a son to perform a financial transaction with the father's credential through the use of a mobile phone associated with the son. In other words, the father will be lending his credential to the son. In the embodiment of the invention depicted in FIG. 8, first mobile phone 801 is one embodiment of personal computing device 300, second mobile phone 802 is one embodiment of mobile computing device 400, point of transaction (“POT”) computer system 803 is one embodiment of point of transaction computer system 600, and financial institution computer system 804 is one embodiment of financial institution computer system 500. In the embodiment of the invention disclosed in FIG. 8, POT computer system 803 is a NFC payment terminal or other similarly equipped payment terminal. Additionally, it will be understood that the mixed block and flow diagram of a system 800 in FIG. 8 represents an embodiment of process flow 100.

At block 805, first mobile phone 801 receives a request from the father to authorize the son to use the father's credential. In the embodiment of the invention depicted at block 805, the father's credential is stored on first mobile phone 701 and the credential contains information about the father's checking account. The father is able to use the e-wallet functionality of first mobile phone 801 with certain payment terminals (e.g., NFC payment terminals, etc.) to perform transaction that are charged to the father's checking account.

At block 805, the father inputs the request through any known application of first mobile phone 801. In some embodiments, the father may input the request through a mobile banking application and/or social network application. In some other embodiments, the father may input the request through a mobile credential lending application. In yet some other embodiments, the father may input the request by sending a txt message to a recipient address affiliated with the financial institution that contains the father's checking account or accessing the financial institution's website through the mobile web browser of first mobile phone 801.

Additionally, at block 805, the father may input the request through any known functionality of first mobile phone 801. In some embodiments, the father may input the request through the use of the keypad or touch pad of first mobile phone 801. In other embodiments, the father may input the request through the use of voice recognition technology or any other input means known to one skilled in the art.

At block 810, first mobile phone 801 receives a parameter that the son can only use the father's credential for making a financial transaction at the grocery store. In this embodiment, first mobile phone 801 receives this parameter from the father through the input functionality of the first mobile phone 801, i.e., keypad, touch screen, voice recognition, etc. In some embodiments of block 810, first mobile phone 801 may prompt the father to input any parameters after first mobile phone 801 receives the request at block 805. In other embodiments, first mobile phone 801 may not prompt the father to input parameters and the father can input them independently through the functionality of first mobile phone 801.

At block 815, first mobile phone 801 receives a parameter that the son can only use the father's credential to spend at most $100 during the financial transaction at the grocery store. In this embodiment, first mobile phone 801 receives this parameter from the father through the input functionality of the first mobile phone 801, i.e., keypad, touch screen, voice recognition, etc. In some embodiments of block 810, first mobile phone 801 may prompt the father to input any additional parameters after first mobile phone 801 receives the first parameter at block 810. In other embodiments, first mobile phone 801 may not prompt the father to input additional parameters and the father can input them independently through the functionality of first mobile phone 801.

At block 820, first mobile phone 801 transmits the un-authenticated credential to second mobile phone 802, along with information about the parameters that the father provided at blocks 810 and 815. The credential is “un-authenticated” because the financial transaction that the father authorized at block 805 has yet to be authorized by financial institution computer system 804. Thus, when the son uses the father's credential to perform a financial transaction at the grocery store, the point of transaction device at the grocery store will need to further authenticate the financial transaction (i.e., authenticate the validity of the father's checking account information, which is stored in the father's credential).

In this embodiment of the invention, the father's credential, which is transmitted from first mobile phone 801 to second mobile phone 802, comprises information that identifies the father's checking account, such as a checking account number and bank routing number.

In this embodiment of block 820, first mobile phone 801 also transmits to second mobile phone 802 information about the parameters that the father provided at blocks 810 and 815. This information is either part of the father's credential or it may be stored as separate data on second mobile phone 802. In some embodiments of the invention, when the son uses the father's credential to perform a financial transaction with a merchant, the merchant's point of transaction device with use the information about the parameters to confirm that the son is using the father's credential pursuant to the father's parameters. For example, if the son tries to use the father's credential at a book store, the point of transaction device at the book store will deny the financial transaction because the information about the father's parameters indicates that the financial transaction must take place at a grocery store.

At block 820, first mobile phone 801 transmits the father's credential and information about the parameters to second mobile phone 802 via a NFC network. However, in some other embodiments, first mobile phone 801 transmits the father's credential and information about the parameters to second mobile phone 802 via the Internet. In still some other embodiments of the invention, first mobile phone 801 transmits the father's credential and information about the parameters to second mobile phone 802 via any known communication protocol or combinations thereof. First mobile phone 801 may transmit the father's credential and information about the parameters to second mobile phone 802 via a wireless network, wireline network or combination thereof. At block 825, second mobile phone 802 receives the father's un-authenticated credential and information about the parameters from first mobile phone 801. In some embodiments of the invention, second mobile phone 802, stores the father's credential and information about the parameters in a memory device in second mobile phone 802.

At block 830, the son uses second mobile phone 802 to perform a financial transaction at the grocery store. In some embodiments of the invention, second mobile phone 802 is equipped with e-wallet functionality, so that second mobile phone 802 may use the father's credential to perform a financial transaction using POT computer system 803. In such embodiments, the son bumps, taps or otherwise physically touches second mobile phone 802 to POT computer system 803 to commence the transaction. As one of skill in the art will appreciate, the son may use any other means known in the art to use second mobile phone 802 to perform a financial transaction using the father's credential.

At block 830, since the financial transaction has not been authorized, in some embodiments, POT computer system 803 may need to authenticate the validity of the credential or the father's checking account. At block 835, POT computer system 803 receives information about the father's checking account information (i.e., account number, routing number, etc.) from second mobile phone 802. In some embodiments of the invention, POT computer system 803 receives the information about the father's checking account from the un-authenticated credential that is stored in second mobile phone 802. In some embodiments of the invention, POT computer system 803 receives the information about the father's checking account when the son uses second mobile phone 802 to perform a financial transaction at the grocery store (See block 830).

Since the credential that was transmitted from the father's first mobile phone 801 to the son's second mobile phone 802 is un-authenticated, at block 840, point of transaction computer system 803 authenticates the financial transaction. In some embodiments of the invention, POT transaction computer system 803 sends a request to authenticate the financial transaction to financial institution computer system 804, which may include, sending information about the father's checking account to financial institution computer system 804 for authentication.

In some embodiments of the invention, POT computer system 803 sends the request to authenticate the financial transaction to financial institution computer system 804 via the Internet. In some other embodiments of the invention, POT computer system 803 sends the request to authenticate the financial transaction to financial institution computer system 804 via any known communication protocol or combinations thereof. POT computer system 803 may send the request to authenticate the financial transaction to financial institution computer system 804 via a wireless network, wireline network or combination thereof. At block 845, financial institution computer system 804 receives the request to authenticate the financial transaction from POT computer system 803.

At block 850, financial institution computer system 804 authenticates the financial transaction that the father authorized the son to perform using the father's credential (see block 805). In this embodiment, where the father authorized the son to spend $100 (see block 815) financial institution computer system 804 verifies that the father's checking account is valid and also determines whether the father's checking account contains at least $100. In some embodiments, financial institution computer system 804 may place a hold on the father's checking account for $100 and in other embodiments, financial institution computer system 804 may immediately deduct the $100 from the father's checking account.

Additionally, at block 850, once the transaction has been authenticated, financial institution computer system 804 transmits an indication to POT computer system 803 that indicates that financial computer system 804 has authenticated the financial transaction. In some other embodiments, financial instruction computer system 804 sends the indication to POT computer system 803 via the Internet. In some other embodiments of the invention, financial instruction computer system 804 sends the indication to POT computer system 803 via any known communication protocol or combinations thereof. Financial institution computer system 804 may send the indication to POT transaction computer system 803 via a wireless network, wireline network or combination thereof. At block 855, POT computer system 803 receives the indication from financial institution computer system 704.

Additionally, at block 855, POT computer system 803 finalizes the financial transaction that the son has made using the father's credential. In some embodiments, POT computer system 803 finalizes the financial transaction by verifying that the son's transaction does comply with the parameters that the father provided at blocks 810 and 815. In some embodiments, POT computer system 803 contains information that indicates that POT computer system 803 is being used at a grocery store, thus the POT computer system 803 is able to verify that the son is complying with the father's store parameter (see block 810). Additionally, in some embodiments, POT computer system 803 will compare the final value of the son's financial transaction to the monetary parameter (e.g., $100 limit) that the father provided at block 815. If the son's transaction is less than or equal to $100 dollars, than POT computer system 803 will allow the son to complete the financial transaction using the father's credential. However, if the son's financial transaction exceeds $100, then in some embodiments, POT computer system 803 will deny the financial transaction. In some other embodiments of the invention, if the son's financial transaction exceeds $100, then POT computer system 803 will allow the son to pay the difference between the sum of the financial transaction and the $100 from the father's parameter.

At block 855, once the son finalizes the financial transaction using the using second mobile phone 802 and the father's credential, then the son leaves the grocery store will the groceries that he purchased.

Although the embodiments of the invention disclosed in relation to FIGS. 7-8 relate to credential lending in the context of financial transactions, as one of skill in the art will appreciate, the systems, methods, and apparatuses of the present invention may involve credential lending relating to other types of transactions (i.e., the first user lending a credential to the second user to allow the second user to conduct different types of transactions.).

For example, in some embodiments of the invention, a first user may lend a credential to a second user that would enable the second user to operate the first user's automobile. Thus, in such an embodiment, the first user may input certain parameters that limit the second user's use of the first user's automobile. For example, the first user could input parameters that limit the times during which the second user can use the first user's automobile (e.g., only on Mondays, from 8 a.m. to 5 p.m., etc.). Additionally, the first user could input parameters that limit the geographic locations in which the second user is authorized to use the first user's automobile (e.g., only in the first user's town, only within the first user's state, etc.).

As another example, in some embodiments, the systems, methods, and apparatuses of the present invention may allow a first user to authorize a second user to enter the first user's home. Thus according to such embodiments, the second user could use a mobile phone containing the first user's credential to open a locked door at the first user's home. In such embodiments, the first user may input certain parameters that limit the second user's ability to open the locked door (e.g., times during which the second user is authorized to open the door, etc.)

As yet an additional example, in some embodiments, the systems, methods, and apparatuses of the present invention may allow a first user to authorize a second user to use the first user's membership (e.g., gym membership, museum membership, rewards program membership, etc.). Thus according to such embodiments, the second user could use a mobile phone containing the first user's credential to access the benefits of the membership. In such embodiments, the first user may input certain parameters that limit the second user's ability to use the membership (e.g., times during which the second user is authorized to use the membership etc.).

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A method implemented by a computing device, wherein the computing device allows a first user to electronically authorize a second user to perform a financial transaction, the method comprising:
providing a processor for executing computer program code stored in a non-transitory computer-readable medium to cause the processor to:
receive a request from the first user to authorize the second user to perform a financial transaction using a financial account of the first user;
receive one or more parameters from the first user restricting a scope of the financial transaction that the second user is authorized to perform;
transmit a credential to a mobile computing device associated with the second user, wherein the credential enables the mobile computing device associated with the second user to communicate with a point of transaction device and complete the financial transaction using the financial account of the first user.

2. The method of claim 1, wherein transmitting a credential comprises transmitting financial information necessary to perform a financial transaction with the financial account of the first user.

3. The method of claim 2, wherein transmitting a credential further comprises transmitting fraud protection codes associated with the financial account of the first user.

4. The method of claim 1, wherein receiving a request from the first user to authorize the second user to perform the financial transaction comprises receiving the request at a mobile phone associated with the first user.

5. The method of claim 1, wherein receiving a request from the first user to authorize the second user to perform the financial transaction comprises receiving the request at a network device in communication with a mobile phone associated with the first user, wherein the request is sent by the mobile phone associated with the first user.

6. The method of claim 1, wherein transmitting a credential to the mobile computing device associated with the second user comprises transmitting the credential from a mobile phone associated with the first user to a mobile phone associated with the second user.

7. The method of claim 1, wherein transmitting a credential to the mobile computing device associated with the second user comprises transmitting the credential to a mobile phone associated with the second user from a network device in communication with the mobile phone associated with the first user.

8. The method of claim 1, wherein receiving a parameter from the first user comprises receiving a monetary parameter, product parameter, merchant parameter, or time period parameter.

9. (canceled)

10. The method of claim 1, wherein transmitting a credential to the mobile computing device associated with the second user further comprises transmitting the one or more parameters to the mobile computing device associated with the second user.

11. The method of claim 1, further comprising receiving authentication information from the first user to use in authenticating the financial transaction performed by the second user.

12. The method of claim 11, further comprising authenticating the financial transaction before the second user has commenced the financial transaction.

13. The method of claim 11, further comprising authenticating the financial transaction after the second user has commenced the financial transaction.

14. The method of claim 11, wherein authenticating the financial transaction comprises authenticating the financial transaction at a network device in communication with the point of transaction device.

15. The method of claim 11, wherein receiving authentication information from the first user comprises receiving authentication information from a mobile phone associated with the first user.

16. The method of claim 1 further comprising:
receiving a proposed financial transaction from the second user;
comparing the proposed financial transaction to the one or more parameters received from the first user; and
approving or denying the financial transaction based on said comparison.

17. An apparatus configured to allow a first user to authorize a second user to perform a financial transaction, the apparatus comprising:
a communication device;
and a processing device communicably coupled to the communication device, wherein the processing device is configured to:
receive a request from the first user to authorize the second user to perform a financial transaction using a financial account of the first user;
receive one or more parameters from the first user restricting a scope of the financial transaction that the second user is authorized to perform;
transmit a credential to a mobile computing device associated with the second user, wherein the credential enables the mobile computing device associated with the second user to communicate with a point of transaction device and complete the financial transaction using the financial account of the first user.

18. The apparatus of claim 17, wherein transmitting a credential comprises transmitting financial information necessary to perform a financial transaction with the financial account of the first user.

19. The apparatus of claim 17, wherein transmitting a credential further comprises transmitting fraud protection codes associated with the financial account of the first user.

20. The apparatus of claim 17, wherein the apparatus is a mobile phone associated with the first user.

21. The apparatus of claim 17, wherein the apparatus is a network device in communication with a mobile phone associated with the first user.

22. The apparatus of claim 17, wherein the mobile computing device associated with the second user is a mobile phone.

23. The apparatus of claim 17, wherein the parameter comprises a monetary parameter, product parameter, merchant parameter, or time period parameter.

24. (canceled)

25. The apparatus of claim 17, wherein the processing device further transmits the one or more parameters to the mobile computing device associated with the second user.

26. The apparatus of claim 17, wherein the processing device is further configured to receive authentication information from the first user to use in authenticating the financial transaction performed by the second user.

27. The apparatus of claim 26, wherein the processing device is further configured to authenticate the financial transaction before the second user has commenced the financial transaction.

28. The apparatus of claim 26, wherein the processing device is further configured to authenticate the financial transaction after the second user has commenced the financial transaction.

29. The apparatus claim 26, wherein the apparatus is a network device in communication with a point of transaction device.

30. The apparatus of claim 26, wherein the processing device is further configured to receive authentication information from a mobile phone associated with the first user.

31. The apparatus of claim 16, wherein said processing device is further configured to:
receive a proposed financial transaction from the second user;
compare the proposed financial transaction to the one or more parameters received from the first user; and
approve or deny the transaction based on said comparison.

32. A computer program product for allowing a first user to authorize a second user to perform a financial transaction, the computer program product comprising a computer-readable medium having computer readable program instructions stored therein, wherein said computer-readable program instructions comprise
first instructions configured for receiving a request from the first user to authorize the second user to perform a financial transaction using an account of the first user;
second instructions configured for receiving one or more parameters from the first user restricting a scope of the financial transaction that the second user is authorized to perform;
third instructions configured for transmitting a credential to a mobile computing device associated with the second user, wherein the credential enables the mobile computing device associated with the second user to communicate with a point of transaction device and complete the financial transaction using the financial account of the first user.

33. The computer program product of claim 32, wherein the third instructions configured for transmitting a credential comprises instructions for transmitting financial information necessary to perform a financial transaction with the financial account of the first user.

34. The computer program product of claim 32, wherein the third instructions configured for transmitting a credential further comprise transmitting fraud protection codes associated with the account of the first user.

35. The computer program product of claim 32, wherein the first instructions configured to receive a request from the first user to authorize the second user to perform the financial transaction comprises instructions configured to receive the request at a mobile phone associated with the first user.

36. The computer program product of claim 32, wherein the first instructions configured to receive a request from the first user to authorize the second user to perform the financial transaction comprise instructions configured to receive the request at a network device in communication with a mobile phone associated with the first user, wherein the request is sent by the mobile phone associated with the first user.

37. The computer program product of claim 32, wherein the third instructions configured to transmit a credential to the mobile computing device associated with the second user comprises instructions configured to transmit the credential from a mobile phone associated with the first user to a mobile phone associated with the second user.

38. The computer program product of claim 32, wherein the third instructions configured to transmit a credential to the mobile computing device associated with the second user comprise instructions configured to transmit the credential to a mobile phone associated with the second user from a network device in communication with the mobile phone.

39. The computer program product of claim 32, wherein the second instructions configured to receive a parameter from the first user comprises receiving a monetary parameter, product parameter, merchant parameter, or time period parameter.

40. (canceled)

41. The computer program product of claim 40, wherein the third instructions configured to transmit a credential to the mobile computing device associated with the second user further comprises instructions configured to transmit the one or more parameters to the mobile computing device associated with the second user.

42. The computer program product of claim 32, further comprising fourth instructions configured to receive authentication information from the first user to use in authenticating the financial transaction performed by the second user.

43. The computer program product of claim 42, wherein the fourth instructions comprises instructions configured to authenticate the financial transaction before the second user has commenced the financial transaction.

44. The computer program product of claim 42, wherein the fourth instructions comprises instructions configured to authenticate the financial transaction after the second user has commenced the financial transaction.

45. The computer program product of claim 42, wherein the fourth instructions comprises instructions configured to authenticate the financial transaction at a network device in communication with a point of transaction device.

46. The computer program product of claim 42, wherein the fourth instructions comprises instructions configured to authenticate a financial transaction based on information received from a mobile phone associated with the first user.

47. The computer program product of claim 32 further comprising fourth instructions for processing a financial transaction, said fourth instructions comprising instructions configure to:
receive a proposed financial transaction from the second user;
compare the proposed financial transaction to the one or more parameters received from the first user; and
approve or deny the financial transaction based on said comparison.

48. The method of claim 2, wherein transmitting a credential further comprises transmitting software that generates fraud protection codes associated with the credential.

49. The apparatus of claim 18, wherein the processing device is further configured to transmit to a mobile computing device associated with the second user software that generates fraud protection codes associated with the credential.
